(19) United States
(12) Patent Application Publication
(10) Pub. No.: US 2021/0087854 A1
(43) Pub. Date: Mar. 25, 2021

(54) A LOCKING DEVICE SET OF LINEAR CONNECTABLE, TUBULAR-SHAPED MODULES

(71) Applicant: 9DESIGN.BE BVBA, Wilrijk (BE)

(72) Inventor: Boutelegier ROEL, Wilrijk (BE)

(21) Appl. No.: 16/956,383

(22) PCT Filed: Dec. 19, 2018
(86) PCT No.: PCT/EP2018/085972

§ 371 Date: Jun. 19, 2020

(30) Foreign Application Priority Data
Dec. 22, 2017 (EP) 17209917.8

(51) Int. Cl. E05B 47/00; E05B 55/00

(52) U.S. Cl. CPC E05B 47/0012; G07C 9/00944; E05B 55/005

(57) ABSTRACT

A locking device set of modules for modular configuration of an electrical locking device comprises a set of linear connectable modules. Each module has a substantially tubular shape with identical outer diameter. The set of connectable modules at least comprises: one or more locking modules; one or more contact controller modules; one or more energy modules. The set of modules enables an installing technician to flexibly configure and install an electrical lock by selecting relevant modules from the set depending on a client's needs, connecting selected modules together in a series to form the electrical lock, and sliding the electrical lock in a drilled hole for built-in installation or in a length-dapted housing or into mounting pieces for built-on installation.

### FIELD OF THE INVENTION

The present invention generally relates to the installation of electrical locks used for any application wherein access to space by humans or animals is controlled, like doors, windows, fences, containers, etc. The invention in particular facilitates dummy-proof, fast and flexible installation of an electrical lock customized to the client's needs.

### BACKGROUND OF THE INVENTION

European patent application EP 2 679 750 A1 entitled “Locking Device Comprising a Deactivation Mechanism” describes an electrical locking device comprising a tubular housing (FIG. 1a: 1) made of steel or aluminum with a length of 20 cm and diameter of 2.5 à 4 cm, a movable latch (FIG. 1a: 4), an electromotor (FIG. 1a: 5), and a deactivation mechanism consisting of a spring (FIG. 1b: 16), a blocking pal (FIG. 1b: 17), a solenoid or magnet (FIG. 1a: 21) and a rod (FIG. 1a: 20, 11). The electromotor moves the latch between a first, closed position (FIG. 1b) and a second, open position (FIG. 1a). The electromotor is actuated through an external signal, received for instance from a badge reader via a controller. In the fail-safe variant of the lock known from EP 2 679 750 A1, the deactivation mechanism (16, 17, 21, 20, 11) retracts the latch to be in an open position (FIG. 1c) when a power interruption occurs. In the fail-secure variant of the lock known from EP 2 679 750 A1, the solenoid (21) is deactivated in case of a power interruption as a result of which the lock remains in closed position (FIG. 1b) during a power outage.

The electrical locking device known from EP 2 679 750 A1 exists in many variants, each equipped with a dedicated controller able to interpret the external signal(s) from a respective actuator. Furthermore, for each of these variants, the fail-safe version and the fail-secure version exists, and a right-opening or left-opening version exists. An installer arriving at a client that requested to have an electrical lock installed, needs to be equipped with all variants and versions of the lock as the client will most likely decide which electrical lock to be installed after the installer has inspected the place where the electrical lock must be installed and after the installer has interrogated the client with respect to his wishes.

U.S. Pat. No. 8,028,553 describes a modular electromechanical lock cylinder. The lock cylinder consists of a housing 44 with cylindrical lock shaft 14 and a lock tab 15 that rotates. The lock tab 15 rotates under control of a coupling device 16, for instance an electric motor or rotary magnet, that is integrated in the housing 44 and operates on signalling received from evaluation electronics 17. The evaluation electronics may be arranged in a rosette 18 mounted on one side of the lock cylinder or may be located in the lock shaft 14 (see Col. 5, lines 4-10). The modularity of the lock cylinder known from U.S. Pat. No. 8,028,553 is to be found in the fact that a reading unit 27, 29 or a receiving unit 42 is separated from the evaluation electronics 17 through integration of such reading unit 27, 29 or receiving unit 42 in different variants 25, 26, 40 of a knob that all fit the shaft ends 22, 23 of the cylindrical lock shaft 14. Although the lock cylinder of U.S. Pat. No. 8,028,553 brings the flexibility to replace a knob 26 by a different knob 40 in order to change the lock control from biometric sensing to manual entry on a keypad, the lock cylinder 11 itself has a complex shape with shaft 14, tab 15 and rosette 18. Such lock cylinder can only be used for built-in installation, has limited pre-configured space as is indicated in Col. 4, lines 30-31, and comes in different installation lengths through produced spacers as is indicated in Col. 3, lines 58-60. Some modularity is achieved through a replaceable knob but the lock cylinder needs to be produced in various lengths, the modularity requires a great variety of knobs to be produced and to be available at installation, and it remains impossible to flexibly configure a lock for a client that desires to control opening/closing through for instance a biometric sensor as well as an mobile application as well as a keypad.

The known electrical locking device consequently lacks flexibility and ease in installation. Installation of an electrical lock is cumbersome and time-consuming for the installer. Typically, no more than one or two installations per workday are achievable.

### SUMMARY OF THE INVENTION

It is an objective of the present invention to increase the flexibility and ease of installing electrical locking devices.

According to the present invention, the above defined objective is achieved by the locking device set of modules for modular configuration of an electrical locking device, defined by claim 1, the locking device set of modules comprising a set of linear connectable modules such that connections between modules enable electrical energy and control signals to be coupled to the next module in line and enable mechanical force to be coupled to the next module in line, each module having a substantially tubular shape with identical outer diameter, the set of connectable modules at least comprising:
one or more locking modules;
one or more contact controller modules;
one or more energy modules
   the set of modules enabling an installing technician to flexibly configure and install an electrical lock by selecting relevant modules from the set depending on a client's needs, connecting selected modules together in a series to form the electrical lock, and sliding the electrical lock in a drilled hole for built-in installation or in a length-adapted housing or into mounting pieces for built-on installation.

Thus, the invention resides in the provision of a set of modules that enables the installing technician to configure an electrical lock in a modular way to the client's needs, and that enables to install the on-site configured electrical lock within minutes either as a built-in or built-on electrical lock. The set of modules thereto comprises modules that have a substantially tubular housing with identical diameter and that are linear connectable such that a bore-hole with appropriate diameter, i.e. the outer diameter of the modules, is sufficient for installation of the electrical lock. The linear connectable modules further enable electrical energy and control signals to be coupled to the next module in line and enable that a mechanical force is coupled to the next module in line. The set of modules comprises one or several locking modules, i.e. modules having a movable latch and some drive mechanism for the movable latch like for instance a motor, one or several contact controller modules, i.e. modules that receive signalling from a user interface, interpret such signalling, and convert such signalling into signalling for the locking module enabling the latter to move the latch in the closed or open position, and one or more energy modules, i.e. energy conversion modules that for instance convert the available AC or DC voltage into the desired AC or DC voltage by the locking and contact controller modules, and/or energy delivering modules like for instance a battery module. The installing technician thus selects the modules on-site depending on the client's needs without having to store and transport various models of electrical locks. Once the modules are selected, the installing technician drills a tubular hole with length corresponding to the aggregate length of the selected modules in the wall, ceiling, door or frame wherein the electrical lock has to be built-in. Alternatively, the installing technician makes use of one or several mounting pieces with cylindrical inner surface or a housing with cylindrical inner surface for built-on installation of the electrical lock. The modules are linear-connected and slit into the drilled hole or mounting pieces or length-adapted housing. Summarizing, the invention resides in a set of linear connectable, tubular-shaped modules that slide into mounting pieces, slide into a tubular shaped, length-adapted housing or slide into a tubular, length-adjusted bore-hole, and that connect serially to actuate a latch. Contact controlling modules can be replaced flexibly. Additional contact modules can be inserted flexibly, provided the length of the bore-hole is adjusted or a new tubular housing with adapted length is produced. The replacement or addition of contact control modules does not require to replace the entire electrical lock by a new electrical lock. The invention substantially reduces the comfort of the installing technician in terms of components he/she has to transport, and substantially improves the efficiency as the overall installation time and complexity of electrical locks reduces significantly.

Embodiments of the locking device set of modules according to the invention, as defined by claim 2, further comprise one or more mounting piecec with cylindrical inner surface whose diameter corresponds to the outer diameter of the modules with tubular shape.

Indeed, for built-on installation, i.e. installation of an electrical lock external to an existing wall, door, window, fence, etc., the electrical lock configured by linearly connecting the tubular shaped modules is mounted using for instance two mounting pieces that also form part of the set of modules. These mounting pieces can be fixedly attached to a wall, door, etc. using screws, and further have cylindrical shaped openings that allow the tubular shaped modules to pass through. Alternatively, the electrical lock may slide into a tubular housing, made for instance of metal, and having an inner diameter that fits the external diameter of the tubular-shaped modules plus some tolerance. The length of such housing may have been cut to fit the aggregate length of the selected tubular shaped modules that jointly form the electrical lock. Alternatively, the selected modules are slit into a sleeve. In case of exterior installation of the electrical lock, the sleeve may have to be waterproof, e.g. an IP67 compliant sleeve.

In embodiments of the locking device set of modules according to the present invention defined by claim 3, the one or more locking modules comprise:
a movable latch;
a motor;
a hydraulic component turning hydraulic pressure into a displacement;
a magnetic component turning magnetic force into a displacement;
a mechanical component turning mechanical force into a displacement;
a fail-secure module.

Indeed, a locking module typically shall comprise a movable latch, a driving component, and possibly a fail-secure module. The movable latch can be moved between a first, protruded position wherein the electrical lock is in its closed state, and a second, retracted position wherein the electrical lock is in its open state. In the closed state, the movable latch is held in its protruded position by a magnet in an additional part of the electrical lock. To move the latch between the first and second position, a drive mechanism is foreseen, for instance an electromotor, or a magnetic, mechanic or hydraulic component applying respectively a magnetic, mechanic or hydraulic generated force on the latch. The fail-secure component ensures that the latch is kept in the protruding position and hence the electrical lock is kept in its closed state in case of an electrical power interruption.

In embodiments of the locking device set of modules according to the present invention, as defined by claim 4, the one or more contact controller modules comprise a Printed Circuit Board or PCB able to receive and interpret signals for opening or closing the electrical locking device, respectively from one or more of:
a badge reader;
a touch panel;
an alphanumeric keyboard;
a fingerprint scanner;
a face recognition camera;
a wireless transmitter in a smart device;
a wide area transmitter in an IoT device.

Thus, depending on the client's wishes to control the opening and closing of the electrical lock, one or plural contact controller modules may be linearly connected in the electrical lock. The installer can flexibly configure the lock according to the client's wishes such that for instance the electrical lock can be opened/closed from an alphanumeric keyboard near the door and a lock/unlock software application installed on the users' smart devices. In another example, the installer may configure an electrical lock that can be opened/closed by inserting a badge in a badge reader, by scanning a fingerprint of the user, or by instructions received from a software application installed on a remote computer like for instance an internet connected office desktop. The advantage of the present invention resides in that the number of combinations of contact controllers the client could come up with is endless, whereas the installer can fast and flexibly configure any possible combination of modules on-site at installation time. The contact controller modules have a tubular shape with outer diameter identical to the outer diameter of the locking module(s) and the energy module(s). A contact controller module further typically has an input interface to receive signalling from a user interface, e.g. a badge reader, touch panel or the like, and/or from a previous linearly connected contact controller module. Each contact controller module further has a Printed Circuit Board or PCB with logic able to interpret the signalling, and an output interface to transmit outgoing signalling to the locking module or to the next linearly connected contact controller module.

In embodiments of the locking device set of modules according to the present invention, as defined by claim 5, the one or more energy modules comprise one or more of:
an AC/DC conversion module;
an AC/AC conversion module;
a DC/DC conversion module;
a DC/AC conversion module; and/or
a battery module.

Thus, the energy module may either be a conversion module, converting the available AC or DC voltage at the location where the electrical lock needs to be installed into the AC or DC voltage required by the other modules of the electrical lock, i.e. the contact controller modules and the locking module. In on example, the electromotor module and contact controller modules operate with a DC supply voltage of 12V. In order to be able to configure the electrical lock on-site such that the available electrical supply voltage can be used, a voltage conversion module, converting the available 220 V AC voltage into the desired 12 V DC voltage may be integrated in the electrical lock.

Embodiments of the locking device set of modules according to the present invention, as defined by claim 6, further comprise a piece with magnet adapted to magnetically lock a movable latch that forms part of said locking module.

Indeed, a separate piece or part that is not linearly connected with the other modules may have a magnet integrated and serve to keep the latch in place when in the protruded position wherein the lock is closed.

Embodiments of the locking device set of modules according to the present invention, as defined by claim 7, further comprise a Bowden cable module comprising a Bowden cable, said Bowden cable module being linearly connectable to the modules and having a substantially tubular shape with identical outer diameter.

Indeed, it may be desirable for the client to have the option at any point in time to mechanically decouple the lock, i.e. to bring the lock in the open position, through simple mechanical force. This may be realised through a Bowden cable that is mechanically connected to the latch in the locking module and that enables to bring the latch in the open position through a pulling force, even from a distance of 10 meters. The Bowden cable may for instance be hidden under a roof, tile, plinth, brim, etc., to serve in emergency situations like for instance a power supply outage to open an electrical lock that is in the fail-secure state.

In embodiments of the locking device set of modules according to the present invention, as defined by claim 8, each module has a substantially cylindrical housing with gutter along the length.

The gutter may for instance serve to return the Bowden cable from one end of the locking device to its other end in situations that require the Bowden cable to be available at the end where also the movable latch is located.

In further embodiments of the locking device set of modules according to the present invention, the inner surface of the gutter is threaded.

This way, the gutter can be used to pull the entire electrical lock out of a bore-hole used for built-in installation. Thereto a screw or threaded instrument may be screwed into the gutter and used to apply a pulling force on the electric lock. The threaded gutter also may be used for screwing a device that holds the electrical lock in position once it is installed, like for instance a screw with flange clamping the lock.

In embodiments of the locking device set of modules according to the present invention, as defined by claim 10, the gutter is dimensioned to hold the Bowden cable.

As mentioned here above, this brings the advantage that the Bowden cable can be returned from one end of the electrical lock to the other end.

Embodiments of the locking device set of modules according to the present invention, as defined by claim 11, further comprise:
a fail-safe module, linearly connectable to the modules and having a substantially tubular shape with identical outer diameter.

Such fail-safe module enables to retract the latch in the locking module in case of a power interruption, such that the electrical lock is brought into a safe, open position rather than a closed position.

### BRIEF DESCRIPTION OF THE DRAWINGS

FIG. 1 shows an electrical locking device 100 configured using an embodiment of the locking device set of modules according to the invention;

FIG. 2 shows another locking device 200 configured using an embodiment of the locking device set of modules according to the invention; and

FIG. 3A and FIG. 3B respectively represent a side view and top view of a locking module that forms part of an embodiment of the locking device set of modules according to the invention.

### DETAILED DESCRIPTION OF EMBODIMENT(S)

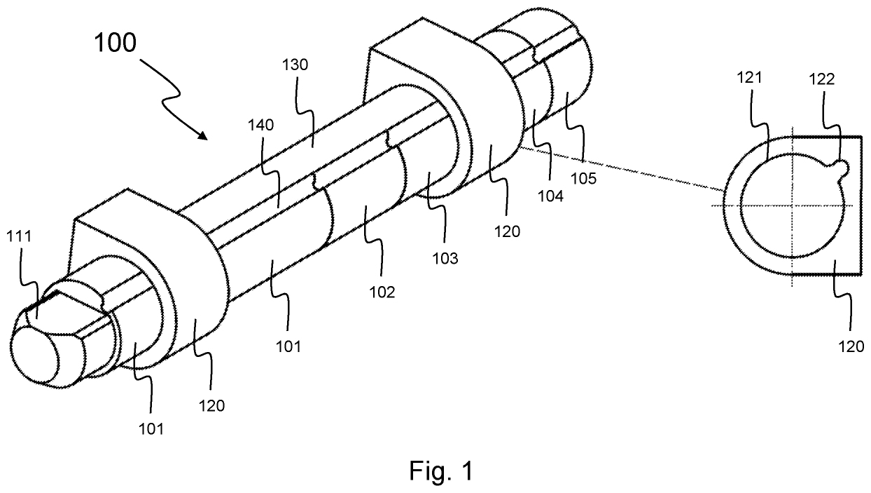

FIG. 1 shows a modular electrical locking device 100 that is configured on-site to be mounted on a door, window, fence or the like. The electrical locking device 100 is composed of modules 101, 102, 103, 104 and 105 that form part of a set of modules. The electrical locking device 100 more particularly consists of a locking module 101 with a movable latch 111 and an electromotor, a first contact controller module 102 for an alphanumeric keyboard that will be installed near the door, window or fence, a second contact controller module 103 with wireless transceiver enabling to control opening/closing of the locking device 100 through an application installed on a smart device, a 220 V AC/12 V DC voltage converter module 104, and a Bowden cable module 105. The locking module 101 has a cylindrical housing of steel with an outer diameter of 4 cm and comprises a latch movable in axial direction. The locking module 101 has a movable latch and comprises an electromotor that moves the latch between a first, closed position and a second, open position. The electromotor is actuated through a signal received from a Printed Circuit Board or PCB integrated in the locking module 101. This PCB receives external signals from contact controller modules that are series connected to the locking module 101. A first contact controller module 102 receives signals from an alphanumeric keyboard that is installed near the door, window or fence. The communication between the alphanumeric keyboard and the first contact controller module 102 may be wired or wireless. This first contact controller module 102 has a cylindrical housing of steel with same outer diameter of 4 cm, and further comprises a PCB that is able to interpret the signals received from the alphanumeric keyboard as well as the signals received from other contact controller modules, and that is able to generate control signals that are outputted to the locking module 101 or possibly other contact controller modules. A second contact controller module 103 receives signals from a software application installed on a smart device. This second contact controller module 103 has a cylindrical housing of steel with same outer diameter of 4 cm, and further comprises a PCB that is able to interpret signals received from the smart device and eventually from other contact controller modules, and that is able to generate control signals that are outputted towards the locking module 101 or possibly other contact controller modules. The voltage converter module 104 converts the available 220 V AC voltage to 12 V DC voltage that is used by the other modules, i.e. the contact controller modules 102, 103, and the locking module 101. The voltage converter module 104 has a cylindrical housing with same diameter of 4 cm, and further comprises voltage conversion circuitry. The Bowden cable module 105 at last also has a cylindrical housing, made of steel, with same diameter of 4 cm, and further comprises a Bowden cable that enables to retract the latch of the locking module 101 mechanically through a pulling force, for instance in case it is in the fail-secure state because of a power interruption.

The modules 101, 102, 103, 104 and 105 are linearly connectable through a click mechanism and as such are series connected on-site by the installer of the electrical locking device 100. The contact controller modules 102, and 103 each have an input connector, a PCB and an output connector for transferring control signals and powering to the next module in line. The input and output connectors may for instance be 10 pins connectors that are respectively electrically connected to the previous and next module in the series connection of modules as a result of the clicking mechanism. The input connector, PCB and output connector may for instance be integrated in a recess of the cylindrical housing. The recess may be covered through a plastic or silicone cover element 130 the outer surface of which is designed to complete the cylindrical housing of the module. The substantially cylindrical housing of the modules 101, 102, 103, 104, and 105 may further have a gutter 140 that serves as cable tray. The cable tray 140 is used to guide the Bowden cable from the Bowden cable module 105 back to the other end of the electrical lock, i.e. the latch 111 to be available there for built-in installations that require the Bowden cable at this end.

[34] FIG. 1 further shows two mounting pieces 120 that enable the technician to mount the electrical lock 100 on a wall, door, etc. The mounting pieces 120 have a substantially cylindrical hole with a cylindrical inner surface 121 the diameter of which corresponds to the outer diameter of the tubular shaped modules 101-105 that jointly constitute the electrical lock 100. As is illustrated by the side-view of mounting piece 120 depicted in FIG. 1, the substantially cylindric hole with inner surface 121 may have a protrusion 122 into the mounting piece 120 enabling to hold a magnet.

The electrical locking device 100 is configured by the installing technician in a modular way to contain the modules desired by the client. The installing technician configures the electrical locking device 100 on-site with the desired contact modules, and installs the electrical lock. The modularity allows the technician to install an electrical locking device 100 fast, and adapt it on-site to the needs of the client without having to store and transport various models of electrical locks. The tubular shaped contact modules 101-105 are series connected through clicking and thereafter slide into the mounting pieces 120 for built-on applications. For built-in applications, the mounting pieces 120 may be useless as a tubular bore-hole with appropriate diameter and length will be drilled into a door, wall, etc. enabling the series connected modules 101-105 to slide into such hole.

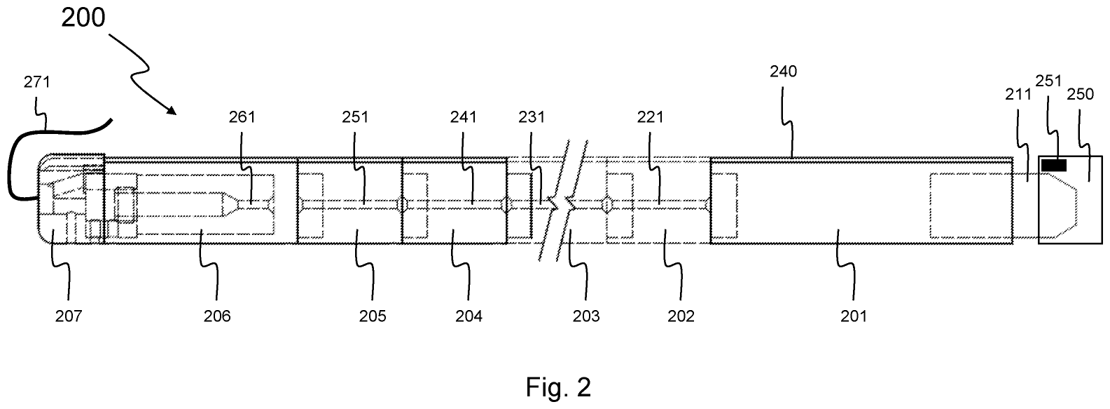

FIG. 2 shows an alternative electrical locking device 200 configured on-site by the installer using the same set of modules according to the present invention. Electrical locking device 200 consists of a locking module 201 with movable latch 211 and electromotor, a first contact controller module 202 that receives control signals from a badge reader, a second contact controller module 203 that receives control signals from a face recognition camera, and a third contact controller module 204 that receives control signals from a software application installed on a remote computer like for instance a desktop PC at the office, a 220 V AC/12 V DC voltage converter module 205, a fail-safe module 206 and a Bowden cable module 207 with Bowden cable 271. FIG. 2 shows that the modules 202, 203, 204, 205 and 206 each have a rod 221, 231, 241, 251 and 261 for transferring mechanical energy to the next series connected module. This enables the Bowden cable module 207 to transfer mechanical energy to the locking module 201 through a pull force applied on Bowden cable 271. Such mechanical force may enable to retract the latch 211 in emergency situations. The electrical locking device 200 illustrated by FIG. 2 has no housing or mounting pieces and therefor is configured for built-in applications. The installer shall drill a bore-hole of appropriate length in a wall, ceiling, door, window, etc. and then slide the series connected modules of electrical lock 200 into the hole. FIG. 2 further shows an additional part 250 with magnet 251 that keeps the latch 211 in closed position. The additional part preferably but not necessarily has a tubular shape with outer diameter identical to the outer diameter of the modules 201-207. In such case, the additional part 250 can be installed using the same bore, drilling a second bore-hole with same diameter. The additional part shall be installed facing the movable latch, for instance in a door frame when the electrical lock 200 is installed in a door. It is possible that the Bowden cable is desired to be available near the latch 211. In such case, the cable 271 is returned from one end of the electrical lock 200 to the other end of the electrical lock via a recess in tubular shaped modules 201-207 that is covered by a silicone cover 240 to complete the cylindrical shape.

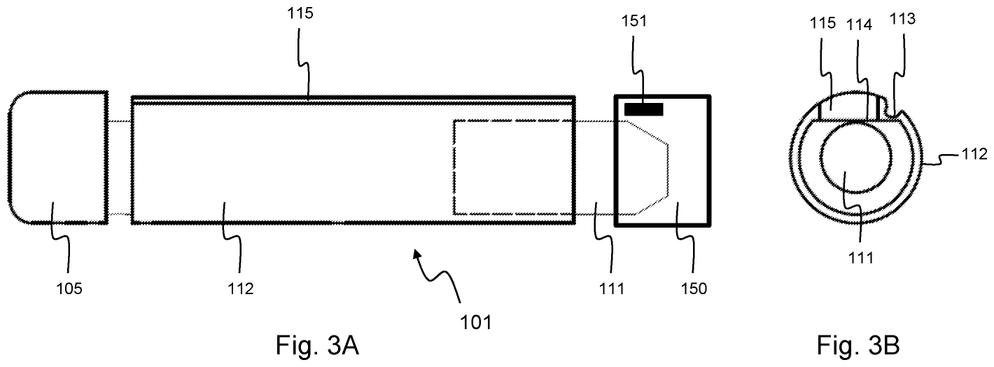

FIG. 3A and FIG. 3B respectively represent a side view and top view of the locking module 101 and Bowden cable module 105, that form part of an embodiment of the set of modules according to the present invention, also used to compose the electrical lock 100 of FIG. 1. The locking module 101 with movable latch 111 and electromotor has a substantially cylindrical housing 112 with a recess 114 that is covered by a plastic or silicone cover 115. The cylindrical housing 112 also has a gutter 113 that serves to return the Bowden cable. The inner surface of gutter 113 may be threaded to enable insertion of a plug and screw that fix the cylindrical housing such that it no longer rotates. The threaded inner surface of gutter 113 also enables to pull the module 101 out of a bore-hole by screwing a screw or other threaded tool into the gutter. In FIG. 3A, the movable latch111 is drawn in closed position wherein it engages with an additional part 150 that has a magnet 151 to hold the latch in position.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, “third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1.-11. (canceled)

12. A locking device set of modules for modular configuration of an electrical locking device, said locking device set of modules comprising a set of linear connectable modules such that connections between modules enable electrical energy and control signals to be coupled to the next module in line and enable mechanical force to be coupled to the next module in line, each module having a substantially tubular shape with identical outer diameter, said set of connectable modules at least comprising:
one or more locking modules;
one or more contact controller modules;
one or more energy modules;
said set of modules enabling an installing technician to flexibly configure and install an electrical lock by selecting relevant modules from said set depending on a client's needs, connecting selected modules together in a series to form said electrical lock, and sliding said electrical lock in a drilled hole for built-in installation or in a length-adapted housing or into mounting pieces for built-on installation.

13. The locking device set of modules according to claim 12, further comprising a mounting piece with cylindrical inner surface whose diameter corresponds to said outer diameter of said modules with tubular shape.

14. The locking device set of modules according to claim 12 wherein said one or more locking modules comprise one or more of:
a movable latch;
a motor;
a hydraulic component turning hydraulic pressure into a displacement;
a magnetic component turning magnetic force into a displacement;
a mechanical component turning mechanical force into a displacement;
a fail-secure module.

15. The locking device set of modules according to claim 12 wherein said one or more contact controller modules comprise a PCB able to receive and interpret signals for opening or closing said electrical locking device, respectively from one or more of:
a badge reader;
a touch panel;
an alphanumeric keyboard;
a fingerprint scanner;
a face recognition camera;
a wireless transmitter in a smart device;
a wide area transmitter in an IoT device.

16. The locking device set of modules according to claim 12, wherein said one or more energy modules comprise one or more of:
an AC/DC conversion module;
an AC/AC conversion module;
a DC/DC conversion module;
a DC/AC conversion module; and/or a battery module.

17. The locking device set of modules according to claim 12, further comprising:
a piece with magnet adapted to magnetically lock a movable latch that forms part of said locking module.

18. The locking device set of modules according to claim 12, further comprising:
a Bowden cable module comprising a Bowden cable, said Bowden cable module being linearly connectable to said modules and having a substantially tubular shape with identical outer diameter.

19. The locking device set of modules according to claim 12, wherein each module has a substantially cylindrical housing with gutter along the length.

20. The locking device set of modules according to claim 19, wherein the inner surface of said gutter is threaded.

21. The locking device set of modules according to claim 18, wherein said gutter is dimensioned to hold said Bowden cable.

22. The locking device set of modules according to claim 12, further comprising:
a fail-safe module, linearly connectable to said modules and having a substantially tubular shape with identical outer diameter.
